(19) United States
(12) Patent Application Publication
(10) Pub. No.: US 2018/0035112 A1
(43) Pub. Date: Feb. 1, 2018

(54) METHOD AND APPARATUS FOR ENCODING AND DECODING VIDEO SIGNAL USING NON-UNIFORM PHASE INTERPOLATION (As Amended)

(71) Applicant: LG Electronics Inc., Seoul (KR)

(72) Inventors: Chulkeun KIM, Seoul (KR); Junghak NAM, Seoul (KR); Seungwook PARK, Seoul (KR); Sehoon YEA, Seoul (KR)

(21) Appl. No.: 15/550,347

(22) PCT Filed: Feb. 3, 2016
(86) PCT No.: PCT/KR2016/001174

§ 371 Date: Aug. 10, 2017

Related U.S. Application Data
(60) Provisional application No. 62/115,650, filed on Feb. 13, 2015.

(51) Int. Cl. H04N 19/117; H04N 19/196; H04N 19/159; H04N 19/82; H04N 19/176

(52) U.S. Cl. CPC H04N 19/117; H04N 19/82; H04N 19/176; H04N 19/159; H04N 19/196; H04N 19/59

(57) ABSTRACT

Disclosed is a method for decoding a video signal, including deriving position information of an integer sample within a target block, performing non-uniform interpolation filtering on the integer sample based on the position information of the integer sample, deriving an interpolation sample value according to a result of the non-uniform interpolation filtering, and obtaining a prediction sample value using the interpolation sample value, wherein the non-uniform interpolation filtering is different in at least one of a phase interval or the number of interpolation samples, the phase interval represents an interval between interpolation samples, and the number of interpolation samples represents the number of interpolation samples generated between integer samples.

### CROSS-REFERENCE TO RELATED APPLICATIONS

This application is the National Stage filing under 35 U.S.C. 371 of International Application No. PCT/KR2016/001174, filed on Feb. 4, 2016, which claims the benefit of U.S. Provisional Application No. 62/115,650, filed on Feb. 13, 2015, the contents of which are all hereby incorporated by reference herein in their entirety.

### TECHNICAL FIELD

The present invention relates to a method and apparatus for encoding/decoding a video signal and, more particularly, to a technique of generating an interpolation sample to enhance prediction performance.

### BACKGROUND ART

Compression coding refers to a series of signal processing technologies for transmitting digitalized information through a communication line or storing the digitalized information in a form appropriate for a storage medium. Media such as video, an image, voice, and the like, may be the subject to compression coding, and in particular, a technology for performing compression coding on video is called video compression.

Next-generation video content is expected to feature high spatial resolution, a high frame rate, and high dimensionality of scene representation. The processing of such content will bring about a significant increase in message storage, a memory access rate, and processing power.

Thus, a coding tool for effectively processing next-generation video content is required to be designed.

In particular, an interpolation filter is applied to a restoration picture to enhance prediction precision. That is, compression performance may be enhanced by generating an interpolation pixel by applying the interpolation filter to an integer pixel and using the generated interpolation pixel as a prediction value. The interpolation method includes various methods such as linear interpolation, bilinear interpolation, a Wiener filter, and the like, but a more effective and adaptive interpolation method is required.

### DISCLOSURE

### Technical Problem

An aspect of the present disclosure provides a method for enhancing coding efficiency through a design of an interpolation filter.

Another aspect of the present disclosure provides an interpolation method considering spatial correlation between pixels

Another aspect of the present disclosure provides an interpolation method in which an interval between interpolation samples differs depending on a distance to a position of an integer pixel.

Another aspect of the present disclosure provides an interpolation method in which an interval between interpolation samples differs in each coding processing unit.

Another aspect of the present disclosure provides a method for adjusting a sample interval to perform non-uniform interpolation.

Another aspect of the present disclosure provides a method for signaling related information to perform non-uniform interpolation.

Another aspect of the present disclosure provides a method for signaling information related to a newly designed interpolation filter.

### Technical Solution

According to an aspect of the present invention, there is provided a method for designing a coding tool for highly efficient compression is provided.

According to another aspect of the present invention, there is provided a method for designing an interpolation filter to improve coding efficiency.

According to another aspect of the present invention, there is provided an interpolation method considering spatial correlation between pixels.

According to another aspect of the present invention, there is provided an interpolation method in which an interval between interpolation samples differs depending on a distance from a position of an integer pixel.

According to another aspect of the present invention, there is provided an interpolation method in which at least one of an internal between interpolation samples and the number of interpolation samples is adjusted in each coding processing unit.

According to another aspect of the present invention, there is provided a method for performing non-uniform interpolation by adjusting a sample interval.

According to another aspect of the present invention, there is provided a method for signaling related information to perform non-uniform interpolation.

According to another aspect of the present invention, there is provided a method for signaling information related to newly designed interpolation filter.

### Advantageous Effects

According to embodiments of the present disclosure, prediction performance and coding efficiency may be enhanced through a design of an interpolation filter.

Also, by performing non-uniform interpolation by adjusting an interval between interpolation samples, prediction precision may be increased and, in addition, coding efficiency may be further enhanced.

Also, by providing a method for signaling information related to a newly designed interpolation filter, coding efficiency may be enhanced.

### DESCRIPTION OF DRAWINGS

FIG. 1 is a schematic block diagram of an encoder encoding a video signal according to an embodiment to which the present disclosure is applied.

FIG. 2 is a schematic block diagram of a decoder decoding a video signal according to an embodiment to which the present disclosure is applied.

FIG. 3 is a view illustrating a partition structure of a coding unit according to an embodiment to which the present disclosure is applied.

FIG. 4 is a view illustrating a prediction unit according to an embodiment to which the present disclosure is applied.

FIG. 5 is a view illustrating integer pixels and subpixels to explain an interpolation method according to an embodiment to which the present disclosure is applied.

FIG. 6 is a view illustrating interpolation filter coefficients according to positions of subpixels regarding a luma component and a chroma component according to an embodiment to which the present disclosure is applied.

FIGS. 7 and 8 are views illustrating an interpolation method performed at the same interval or different intervals between samples according to an embodiment to which the present disclosure is applied.

FIGS. 9 and 10 are views illustrating a syntax structure for signaling an interpolation flag representing an interpolation method according to an embodiment to which the present disclosure is applied.

FIG. 11 is a view illustrating a method for performing interpolation based on a phase interval flag according to an embodiment to which the present disclosure is applied.

FIG. 12 is a schematic block diagram of an inter-prediction unit performing interpolation using an interpolation flag according to an embodiment to which the present disclosure is applied.

FIG. 13 is a flow chart illustrating performing non-uniform interpolation filtering according to an embodiment to which the present disclosure is applied.

FIG. 14 is a flow chart illustrating performing non-uniform interpolation filtering based on an interpolation flag according to an embodiment to which the present disclosure is applied.

### BEST MODES

The present disclosure provides a method for decoding a video signal, including: deriving position information of an integer sample within a target block; performing non-uniform interpolation filtering on the integer sample based on the position information of the integer sample; deriving an interpolation sample value according to a result of the non-uniform interpolation filtering; and obtaining a prediction sample value using the interpolation sample value, wherein the non-uniform interpolation filtering is different in at least one of a phase interval or the number of interpolation samples, the phase interval represents an interval between interpolation samples, and the number of interpolation samples represents the number of interpolation samples generated between integer samples.

Also, in the present disclosure, the phase interval may be narrower toward the integer sample.

Also, in the present disclosure, the phase interval may be determined based on the number of interpolation samples, or be pre-determined.

Also, in the present disclosure, the method may further include: obtaining an interpolation flag representing an interpolation method, wherein whether to perform the non-uniform interpolation filtering is determined based on the interpolation flag.

Also, in the present disclosure, the interpolation flag may represent whether the non-uniform interpolation filtering is performed.

Also, in the present disclosure, the interpolation flag may be extracted from at least one of a sequence parameter set (SPS), a picture parameter set (PPS), a slice, a coding unit (CU), a prediction unit (PU), a block, a polygon, and a processing unit.

Also, in the present disclosure, the non-uniform interpolation filtering may be applied differently to each prediction unit.

The present disclosure also provides an apparatus for decoding a video signal, including: an interpolation filtering unit deriving position information of an integer sample within a target block, performing non-uniform interpolation filtering on the integer sample based on the position information of the integer sample, and deriving an interpolation sample value according to a result of the non-uniform interpolation filtering; and a predictor generating unit obtaining a prediction sample value using the interpolation sample value, wherein the non-uniform interpolation filtering is different in at least one of a phase interval or the number of interpolation samples, the phase interval represents an interval between interpolation samples, and the number of interpolation samples represents the number of interpolation samples generated between integer samples.

Also, in the present disclosure, the apparatus may further include: a filtering determining unit obtaining an interpolation flag representing an interpolation method, wherein whether to perform the non-uniform interpolation filtering is determined based on the interpolation flag.

### MODE FOR INVENTION

Hereinafter, exemplary elements and operations in accordance with embodiments of the present invention are described with reference to the accompanying drawings. The elements and operations of the present invention that are described with reference to the drawings illustrate only embodiments, which do not limit the technical spirit of the present invention and core constructions and operations thereof.

Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be construed as being based on only the name of a term used in a corresponding description of this specification and that the present invention should be construed by checking even the meaning of a corresponding term.

Furthermore, terms used in this specification are common terms selected to describe the invention, but may be replaced with other terms for more appropriate analyses if other terms having similar meanings are present. For example, a signal, data, a sample, a picture, a frame, and a block may be properly replaced and interpreted in each coding process. And, partitioning, decomposition, splitting, and division may be properly replaced and interpreted in each coding process.

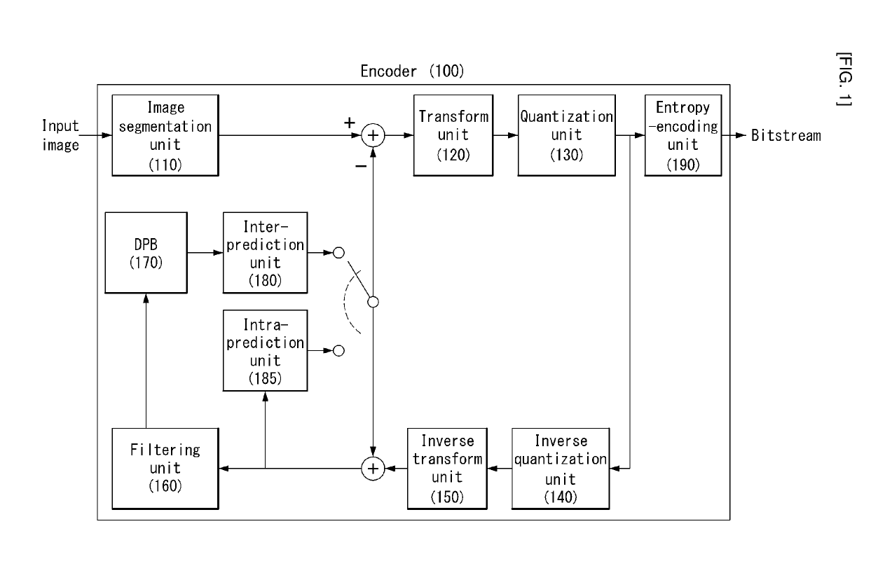

FIG. 1 shows a schematic block diagram of an encoder for encoding a video signal, in accordance with one embodiment of the present invention.

Referring to FIG. 1, an encoder 100 may include an image segmentation unit 110, a transform unit 120, a quantization unit 130, an inverse quantization unit 140, an inverse transform unit 150, a filtering unit 160, a DPB (Decoded Picture Buffer) 170, an inter-prediction unit 180, an intra-prediction unit 185 and an entropy-encoding unit 190.

The image segmentation unit 110 may divide an input image (or, a picture, a frame) input to the encoder 100 into one or more process units. For example, the process unit may be a coding tree unit (CTU), a coding unit (CU), a prediction unit (PU), or a transform unit (TU).

However, the terms are used only for convenience of illustration of the present disclosure. The present invention is not limited to the definitions of the terms. In this specification, for convenience of illustration, the term “coding unit” is employed as a unit used in a process of encoding or decoding a video signal. However, the present invention is not limited thereto. Another process unit may be appropriately selected based on contents of the present disclosure.

The encoder 100 may generate a residual signal by subtracting a prediction signal output from the inter-prediction unit 180 or intra prediction unit 185 from the input image signal. The generated residual signal may be transmitted to the transform unit 120.

The transform unit 120 may apply a transform technique to the residual signal to produce a transform coefficient. The transform process may be applied to a pixel block having the same size of a square, or to a block of a variable size other than a square.

The quantization unit 130 may quantize the transform coefficient and transmits the quantized coefficient to the entropy-encoding unit 190. The entropy-encoding unit 190 may entropy-code the quantized signal and then output the entropy-coded signal as bit streams.

The quantized signal output from the quantization unit 130 may be used to generate a prediction signal. For example, the quantized signal may be subjected to an inverse quantization and an inverse transform via the inverse quantization unit 140 and the inverse transform unit 150 in the loop respectively to reconstruct a residual signal. The reconstructed residual signal may be added to the prediction signal output from the inter-prediction unit 180 or intra-prediction unit 185 to generate a reconstructed signal.

On the other hand, in the compression process, adjacent blocks may be quantized by different quantization parameters, so that deterioration of the block boundary may occur. This phenomenon is called blocking artifacts. This is one of important factors for evaluating image quality. A filtering process may be performed to reduce such deterioration. Using the filtering process, the blocking deterioration may be eliminated, and, at the same time, an error of a current picture may be reduced, thereby improving the image quality.

The filtering unit 160 may apply filtering to the reconstructed signal and then outputs the filtered reconstructed signal to a reproducing device or the decoded picture buffer 170. The filtered signal transmitted to the decoded picture buffer 170 may be used as a reference picture in the inter-prediction unit 180. In this way, using the filtered picture as the reference picture in the inter-picture prediction mode, not only the picture quality but also the coding efficiency may be improved.

The decoded picture buffer 170 may store the filtered picture for use as the reference picture in the inter-prediction unit 180.

The inter-prediction unit 180 may perform temporal prediction and/or spatial prediction with reference to the reconstructed picture to remove temporal redundancy and/or spatial redundancy. In this case, the reference picture used for the prediction may be a transformed signal obtained via the quantization and inverse quantization on a block basis in the previous encoding/decoding. Thus, this may result in blocking artifacts or ringing artifacts.

Accordingly, in order to solve the performance degradation due to the discontinuity or quantization of the signal, the inter-prediction unit 180 may interpolate signals between pixels on a subpixel basis using a low-pass filter. In this case, the subpixel may mean a virtual pixel generated by applying an interpolation filter. An integer pixel means an actual pixel existing in the reconstructed picture. The interpolation method may include linear interpolation, bi-linear interpolation and Wiener filter, etc.

The interpolation filter may be applied to the reconstructed picture to improve the accuracy of the prediction. For example, the inter-prediction unit 180 may apply the interpolation filter to integer pixels to generate interpolated pixels. The inter-prediction unit 180 may perform prediction using an interpolated block composed of the interpolated pixels as a prediction block.

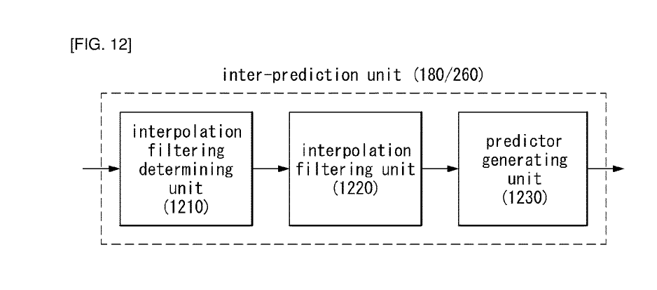

The inter-prediction unit 180 may include an interpolation filtering determining unit 1210, an interpolation filtering unit 1220, and a predictor generating unit 1230, and details thereof will be described with reference to FIG. 12 hereinafter.

According to an embodiment of the present disclosure, the inter-prediction unit 180 may perform non-uniform interpolation filtering on an integer sample based on position information of the integer sample, and the non-uniform interpolation filtering may refer to interpolation filtering different in at least one of a phase interval or the number of interpolation samples. Here, the phase interval may represent an interval between interpolation samples, and the number of interpolation samples may represent the number of interpolation samples generated between integer samples.

In another embodiment, the phase interval may be narrower toward the integer sample.

Also, in another embodiment of the present disclosure, an interpolation flag representing an interpolation method is obtained, and whether to perform non-uniform interpolation filtering may be determined based on the obtained interpolation flag. Here, the interpolation flag may represent whether to perform non-uniform interpolation filtering.

Also, in another example, the interpolation flag may be extracted from at least one of a sequence parameter set (SPS), a picture parameter set (PPS), a slice, a coding unit (CU), a prediction unit (PU), a block, a polygon, and a processing unit.

Also, in another embodiment, the non-uniform interpolation filtering may be applied differently to each prediction unit.

Meanwhile, the intra-prediction unit 185 may predict a current block by referring to samples in the vicinity of a block to be encoded currently. The intra-prediction unit 185 may perform a following procedure to perform intra prediction. First, the intra-prediction unit 185 may prepare reference samples needed to generate a prediction signal. Then, the intra-prediction unit 185 may generate the prediction signal using the prepared reference samples. Thereafter, the intra-prediction unit 185 may encode a prediction mode. At this time, reference samples may be prepared through reference sample padding and/or reference sample filtering. Since the reference samples have undergone the prediction and reconstruction process, a quantization error may exist. Therefore, in order to reduce such errors, a reference sample filtering process may be performed for each prediction mode used for intra-prediction.

The prediction signal generated via the inter-prediction unit 180 or the intra-prediction unit 185 may be used to generate the reconstructed signal or used to generate the residual signal.

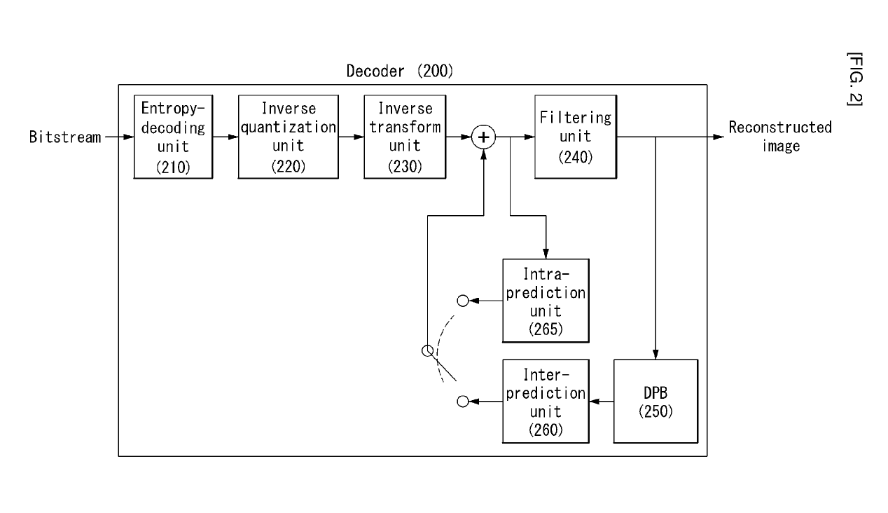

FIG. 2 shows a schematic block diagram of a decoder for decoding a video signal, in accordance with one embodiment of the present invention.

Referring to FIG. 2, a decoder 200 may include an entropy-decoding unit 210, an inverse quantization unit 220, an inverse transform unit 230, a filtering unit 240, a decoded picture buffer (DPB) 250, an inter-prediction unit 260 and an intra-prediction unit 265.

A reconstructed video signal output from the decoder 200 may be reproduced using a reproducing device.

The decoder 200 may receive the signal output from the encoder as shown in FIG. 1. The received signal may be entropy-decoded via the entropy-decoding unit 210.

The inverse quantization unit 220 may obtain a transform coefficient from the entropy-decoded signal using quantization step size information.

The inverse transform unit 230 may inverse-transform the transform coefficient to obtain a residual signal.

A reconstructed signal may be generated by adding the obtained residual signal to the prediction signal output from the inter-prediction unit 260 or the intra-prediction unit 265.

The filtering unit 240 may apply filtering to the reconstructed signal and may output the filtered reconstructed signal to the reproducing device or the decoded picture buffer unit 250. The filtered signal transmitted to the decoded picture buffer unit 250 may be used as a reference picture in the inter-prediction unit 260.

Herein, detailed descriptions for the filtering unit 160, the inter-prediction unit 180 and the intra-prediction unit 185 of the encoder 100 may be equally applied to the filtering unit 240, the inter-prediction unit 260 and the intra-prediction unit 265 of the decoder 200 respectively.

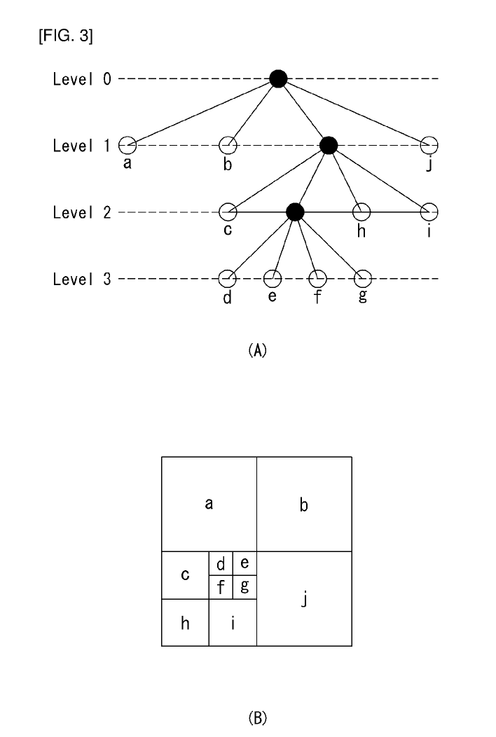

FIG. 3 is a view illustrating a partition structure of a coding unit according to an embodiment to which the present disclosure is applied.

An encoder may partition an image (or picture) by rectangular coding tree units (CTUs). Also, the encoder sequentially encodes the CTUs one after another in raster scan order.

For example, a size of the CTU may be determined to any one of 64×64, 32×32, and 16×16, but the present disclosure is not limited thereto. The encoder may selectively use a size of the CTU depending on resolution or characteristics of an input image. The CTU may include a coding tree block (CTB) regarding a luma component and a CTB regarding two chroma components corresponding thereto.

One CTU may be decomposed into a quadtree (QT) structure. For example, one CTU may be partitioned into four equal-sized square units and having each side whose length is halved each time. Decomposition according to the QT structure may be performed recursively.

Referring to FIG. 3, a root node of the QT may be related to the CTU. The QT may be divided until it reaches a leaf node, and here, the leaf node may be termed a coding unit (CU).

The CU may be a basic unit for coding based on which processing an input image, for example, intra/inter prediction is carried out. The CU may include a coding block (CB) regarding a luma component and a CB regarding two chroma components corresponding thereto. For example, a size of the CU may be determined to any one of 64×64, 32×32, 16×16, and 8×8, but the present disclosure is not limited thereto and the size of the CPU may be increased or diversified in the case of a high definition image.

Referring to FIG. 3, the CTU corresponds to a root node and has a smallest depth (i.e., level 0). The CTU may not be divided depending on characteristics of an input image and, in this case, the CTU corresponds to a CU.

The CTU may be decomposed into a QT form and, as a result, lower nodes having a depth of level 1 may be generated. A node (i.e., a leaf node) which is not partitioned any further, among the lower nodes having the depth of level 1, corresponds to a CU. For example, in FIG. 3(b), CU(a), CU(b), and CU(j) respectively corresponding to nodes a, b, and j have been once partitioned and have the depth of level 1.

At least one of the nodes having the depth of level 1 may be divided again into the QT form. Also, a node (i.e., a leaf node) which is not divided any further among the lower nodes having a depth of level 2 corresponds to a CU. For example, in FIG. 3(b), CU(c), CU(h), and CU(i) respectively corresponding to nodes c, h, and I have been divided twice and have the depth of level 2.

Also, at least one of the nodes having the depth of level 2 may be divided again in the QT form. Also, a node (leaf node) which is not divided any further among the lower nodes having a depth of level 3 corresponds to a CU. For example, in FIG. 3(b), CU(d), CU(e), CU(f), and CU(g) respectively corresponding to nodes d, e, f, and g have been divided three times and have the depth of level 3.

In the encoder, a largest size or a smallest size of a CPU may be determined according to characteristics (e.g., resolution) of a video image or in consideration of efficiency of coding. Also, information regarding the determined largest size or smallest size of the CU or information deriving the same may be included in a bit stream. A CPU having a largest size may be termed a largest coding unit (LCU) and a CU having a smallest size may be termed a smallest coding unit (SCU).

Also, the CU having a tree structure may be hierarchically divided with predetermined largest depth information (or largest level information). Also, each of the divided CUs may have depth information. Since the depth information represents the number by which a CU has been divided and/or a degree to which the CU has been divided, the depth information may include information regarding a size of the CU.

Since the LCU is divided into the QT form, a size of the SCU may be obtained using a size of the LCU and largest depth information. Or, conversely, a size of the LCU may be obtained using the size of the SCU and largest depth information of a tree.

Regarding one CU, information representing whether the corresponding CU is partitioned may be delivered to the decoder. For example, the information may be defined as a split flag and represented by a syntax element “split_cu_flag”. The split flag may be included in every CU except for the SCU. For example, if the value of the split flag is ‘1’, the corresponding CU is partitioned again into four CUs, while if the split flag is ‘0’, the corresponding CU is not partitioned further, but a coding process with respect to the corresponding CU may be carried out.

Although the embodiment of FIG. 3 has been described with respect to a partitioning process of a CU, the QT structure may also be applied to the transform unit (TU) which is a basic unit carrying out transformation.

A TU may be partitioned hierarchically into a quadtree structure from a CU to be coded. For example, the CU may correspond to a root node of a tree for the TU.

Since the TU may be partitioned into a QT structure, the TU partitioned from the CU may be partitioned into smaller TUs. For example, the size of the TU may be determined by any one of 32×32, 16×16, 8×8, and 4×4. However, the present invention is not limited thereto and, in the case of a high definition image, the TU size may be larger or diversified.

For each TU, information regarding whether the corresponding TU is partitioned may be delivered to the decoder. For example, the information may be defined as a split transform flag and represented as a syntax element “split_transform_flag”.

The split transform flag may be included in all of the TUs except for a TU having a smallest size. For example, when the value of the split transform flag is ‘1’, the corresponding CU is partitioned again into four TUs, and when the split transform flag is ‘0’, the corresponding TU is not partitioned further.

As described above, a CU is a basic coding unit, based on which intra- or inter-prediction is carried out. In order to more effectively code an input image, a CU can be decomposed into prediction units (PUs).

A PU is a basic unit for generating a prediction block; prediction blocks may be generated differently in units of PUs even within one CU. A PU may be partitioned differently according to whether an intra-prediction mode or an inter-prediction mode is used as a coding mode of the CU to which the PU belongs.

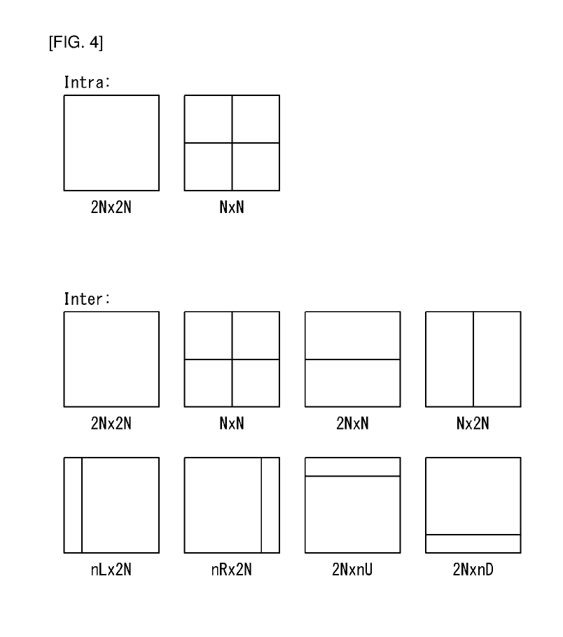

FIG. 4 is a view illustrating a prediction unit according to an embodiment to which the present disclosure is applied.

A PU is partitioned differently depending only whether an intra-prediction mode is used or inter-prediction mode is used as a coding mode of a CU to which the PU belongs.

FIG. 4(a) illustrates a PU when the intra-prediction mode is used and FIG. 4(b) illustrates a PU when the inter-prediction mode is used.

Referring to FIG. 4(a), when it is assumed that a size of a CU is 2N×2N(N=4, 8, 16, 32), one CU may be partitioned into two types (i.e., 2N×2N [symbol] N×N).

Here, when a CU is partitioned into PUs in the form of 2N×2N, it means that only one PU is present within one CU.

Meanwhile, when a CU is partitioned into PUs in the form of N×N, one CU is partitioned into four Pus and different prediction blocks are generated for each PU unit. However, partitioning the PU may be performed only when a size of a CB regarding a luma component of the CU is a smallest size (i.e., when the CU is an SCU).

Referring to FIG. 4(b), when a case in which a size of one CU is 2N×2N (N=4, 8, 16, 32) is assumed, one CU may be partitioned into eight PU types (i.e., 2N×2N, N×N, 2N×N, N×2N, nL×2N, nR×2N, 2N×nU, 2N×nD).

Similar to intra-prediction, the PU partition in the form of N×N may be carried out only when a size of a CB regarding a luma component of a CU is a smallest size (that is, when a CU is an SCU).

In the inter-prediction, PU partitioning in the form of 2N×N in which a PU is partitioned in a transverse direction and in the form of N×2N in which a PU is partition in a longitudinal direction are supported.

Also, PU partitioning in the form of nL×2N, nR×2N, 2N×nU, and 2N×nD as asymmetric motion partitioning (AMP) is supported. Here, “n” refers to ¼ of 2N. However, AMP may not be used in cases where a CU to which a PU belongs is a CU having a smallest size.

In order to effectively code an input image of one CTU, an optimal partitioning structure of a coding unit (CU), a prediction unit (PU), and a transform unit (TU) may be determined based on a minimum rate-distortion) value through the following process. For example, as for a process of an optimal CU partitioning within 64×64 CTU, rate-distortion cost, while performing a partitioning process from a CU having a size of 64×64 to a CU having a size of 8×8, may be calculated. Details thereof are as follows.

1) Inter/intra prediction, transform/quantization, inverse quantization/inverse transform, and entropy encoding are performed on a CU having a size of 64×64 to determine an optimal partitioning structure of a PU and a TU generating a minimum rate-distortion value.

2) A 64×64 CU is partitioned to four CUs having a size of 32×32, and an optimal partitioning structure of a PU and a TU generating a minimum rate-distortion value is determined for each 32×32 cu.

3) The 32×32 CU is partitioned again to four CUs having a size of 16×16, and an optimal partitioning structure of a PU and a TU generating a minimum rate-distortion value is determined for each 16×16 CU.

4) The 16×16 CU is partitioned again to four CUs having a size of 8×8, and an optimal partitioning structure of a PU and a TU generating a minimum rate-distortion value is determined for each 8×8 CU.

5) An optimal CU partitioning structure within the 16×16 block is determined by comparing the sum of the rate-distortion value of 16×16 CU calculated in the process of 3) and the rate-distortion values of four 8×8 CUs calculated in the process of 4). This process is also performed on the other three 16×16 CUs in the same manner.

6) An optimal CU partitioning structure within the 32×32 block is determined by comparing the sum of the rate-distortion value of 32×32 CU calculated in the process of 2) and the rate-distortion values of four 16×16 CUs obtained in the process of 5). This process is also performed on the other three 32×32 CUs in the same manner.

7) Finally, an optimal CU partitioning structure within the 64×64 block is determined by comparing the sum of the rate-distortion value of 64×64 CUs calculated in the process of 1) and the rate-distortion values of four 32×32 CUs obtained in the process of 6).

In the intra-prediction mode, a prediction mode is selected in units of PUs, and prediction and reconstruction is carried out in actual units of TUs on the selected prediction mode.

The TU refers to a basic unit by which actual prediction and reconstruction are carried out. The TU includes a transform block (TB) regarding a luma component and a TB regarding two chroma components corresponding thereto.

In the foregoing example of FIG. 3, like one CTU is partitioned into a QT structure to generate CUs, a TU is hierarchically partitioned into a QT structure from one CU.

Since the TU is partitioned to a QT structure, the TU partitioned from a CU may be partitioned into smaller TUs again. In HEVC, a size of a TU may be determined to any one of 32×32, 16×16, 8×8, 4×4.

Referring back to FIG. 3, it is assumed that a root node of a QT is related to a CU. A QT is partitioned until it reaches a leaf node, and the leaf node corresponds to a TU.

In detail, a CU corresponds to a root node and has a smallest depth (i.e., depth=0). The CU may not be partitioned according to characteristics of an input image, and in this case, the CU corresponds to a TU.

The CU may be partitioned to a QT form, and as a result, lower nodes having a depth of 1 (depth=1) are generated. Among the lower nodes having the depth of 1, a node which is not partitioned any further (i.e., a leaf node) corresponds to a TU. For example, in FIG. 3(b), TU(a), TU(b), and TU(j) respectively corresponding to a, b, and j have been once partitioned from a CU and have a depth of 1.

At least any one of nodes having the depth of 1 may also be partitioned to a QT form, and as a result, lower nodes having a depth of 2 (i.e., depth=2) are generated. Among the lower nodes having the depth of 2, a node which is not partitioned any further (i.e., a lead node) corresponds to a TU. For example, in FIG. 3(b), TU(c), TU(h), and TU(i) respectively corresponding to c, h, and I have been partitioned twice from a CU and have the depth of 2.

Also, at least one of nodes having the depth of 2 may be partitioned again to a QT form, and as a result, lower nodes having a depth of 3 (i.e., depth=3) are generated. Among the lower nodes having the depth of 3, a node which is not partitioned any further (i.e., a leaf node) corresponds to a CU. For example, in FIG. 3(b), TU(d), TU(e), TU(f), and TU(g) respectively corresponding to nodes d, e, f, and g have been partitioned three times and have the depth of 3.

The TU having a tree structure may be hierarchically partitioned with predetermined largest depth information (or largest level information). Also, each of the partitioned TUs may have depth information. Since depth information represents the number by which the TU has been partitioned and/or a degree to which the TU has been divided, the depth information may include information regarding a size of the TU.

Regarding one TU, information (e.g., a split TU flag (split_transform_flag) representing whether the corresponding TU is partitioned may be delivered to the decoder. The split information is included in every TU except for a TU having a smallest size. For example, if the value of the flag representing partition is ‘1’, the corresponding TU is partitioned again into four TUs, while if the flag representing partition is ‘0’, the corresponding CU is not partitioned any further.

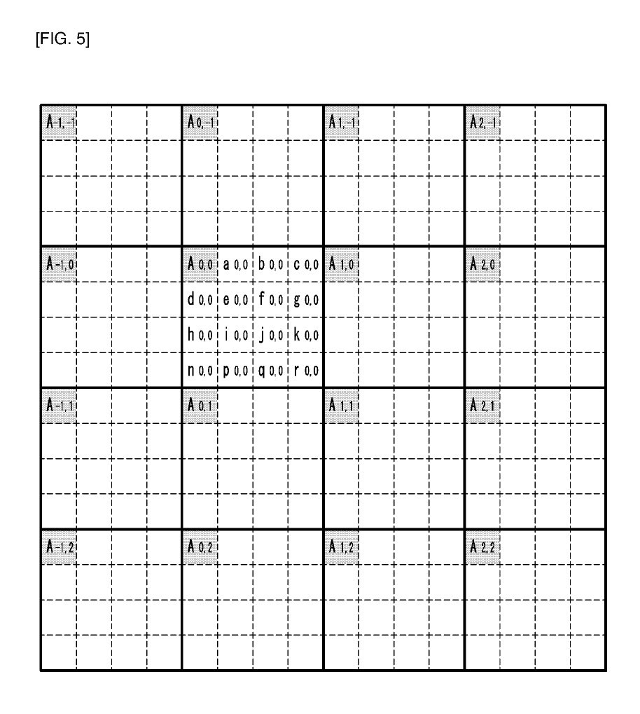

FIG. 5 is a view illustrating integer pixels and subpixels to explain an interpolation method according to an embodiment to which the present disclosure is applied.

The encoder or the decoder may generate an interpolation pixel by applying an interpolation filter to an integer pixel and perform prediction using the interpolation pixel. The interpolation pixel may be expressed as a fractional pixel or a sub-pixel. For example, the interpolation pixel may include a ½ pixel (hereinafter, referred to as a “half pixel”), a ¼ pixel (hereinafter, referred to as a “quarter pixel”), a ⅛ pixel, and the like, but the present disclosure is not limited thereto.

For example, in an interpolation method, first, a sample value in a half-sample may be generated, and a sample value in an integer sample position and the sample value in the half sample position may be averaged to generate an interpolation pixel. In another example, in the case of a luma component, a symmetrical 8-tap filter may be applied to the position of the half pixel and an asymmetrical 7-tap filter may be applied to a position of a quarter pixel. Also, in the case of a chroma component, a 4-tap filter may be applied.

FIG. 5 illustrates relative positions of integer pixels and sub-pixels in a block. The integer pixel may be expressed as A, a non-integer pixel (a fractional pixel or a sub-pixel) may be expressed as, b, c, d, e, f, g, h, i, j, k, n, p, q, r, and coordinates of each pixel may be expressed as a subscript (x,y).

In an embodiment of the interpolation, in the case of a luma component, a maximum of 16 prediction candidate blocks are generated by applying four types of one-dimensional 8-tap filter in a horizontal direction and a vertical direction, and in the case of a chroma component, a maximum of 64 prediction candidate blocks may be generated by applying eight types of one-dimensional 4-tap filter in the horizontal direction and vertical direction.

For example, an interpolation pixel in a position of (a, b, c) may be generated by applying the interpolation filter in the horizontal direction, and an interpolation pixel in a position of (d, e, f, g, h, i, j, k, n, p, q, r) may be generated by applying the interpolation filter in the vertical direction. That is, an additional reference block or reference image may be obtained by applying the interpolation filter to integer pixels.

The decoder may generate an interpolation block using sub-pixel information and reference information transmitted from the encoder, and prediction precision may be enhanced using the interpolation block.

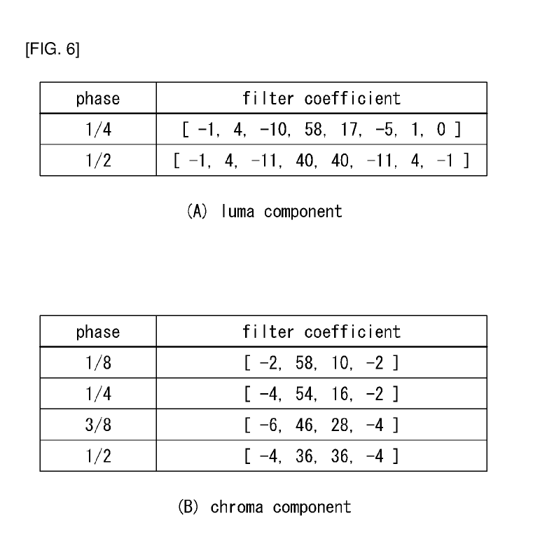

FIG. 6 is a view illustrating interpolation filter coefficients according to positions of subpixels regarding a luma component and a chroma component according to an embodiment to which the present disclosure is applied.

In an embodiment of an interpolation method, in the case of a luma component, samples in positions of a, b, c, d, h, and n of FIG. 5 may be derived from samples in the position of A. In detail, an 8-tap filter may be applied to pixels in the half sample position and a 7-tap filter may be applied to pixels in the quarter sample position. For example, samples in the positions of b and h may be derived by applying the 8-tap filter, and samples in the positions of a, c, d, and n may be derived by applying the 7-tap filter.

When the filter coefficient of the luma component of FIG. 6(a) is applied, the filter coefficients may be defined as shown in Table 1 and sub-sample values as expressed by Equation 1 may be obtained by applying the filter coefficients.

TABLE 1

index

| | −3 | −2 | −1 | 0 | 1 | 2 | 3 | 4 |
|---|---|---|---|---|---|---|---|---|
| F_{q}[i] | −1 | 4 | −10 | 58 | 17 | −5 | 1 | |
| Fₕ[i] | −1 | 4 | −11 | 40 | 40 | −11 | 4 | −1 |

a_{0,i}=(Σ_{i=-3 . . . 3}A_{i,j}F_{q}[i])>>(B−8)

b_{0,i}=(Σ_{i=-3 . . . 4}A_{i,j}Fₕ[i])>>(B−8)

c_{0,i}=(Σ_{i=-2 . . . 4}A_{i,j}F_{q}[1−i])>>(B−8)

d_{0,0}=(Σ_{i=-3 . . . 3}A_{0,j}F_{q}[j])>>(B−8)

h_{0,0}=(Σ_{i=-3 . . . 4}A_{0,j}Fₕ[j])>>(B−8)

n_{0,0}=(Σ_{i=-2 . . . 4}A_{0,j}F_{q}[1−j])>>(B−8) [Equation 1]

Here, B denotes a bit depth of a reference sample.

Sample values in the other remaining positions of (e, f, g, i, j, k, p, q, r) may be derived by applying a corresponding filter to samples in vertically adjusted positions of a, b, and c.

When the filter coefficient of chroma component of FIG. 6(b) is applied, filter coefficients may be defined as illustrated in Table 2, and, like in the luma component, sub-sample values may be obtained by applying filter coefficients. In the case of chroma component, sample values in positions of ⅛, 2/8, ⅜, and 4/8 may be derived using the filter coefficients of Table 2, and sample values in positions of ⅝, 6/8, and ⅞ may be derived using mirrored values of F₃[1-i], F₂[1-i], and F₁[1-i].

TABLE 2

| index | −1 | 0 | 1 | 2 |
|---|---|---|---|---|
| F₁[i] | −2 | 58 | 10 | −2 |
| F₂[i] | −4 | 54 | 16 | −2 |
| F₃[i] | −6 | 46 | 28 | −4 |
| F₄[i] | −4 | 36 | 36 | −4 |

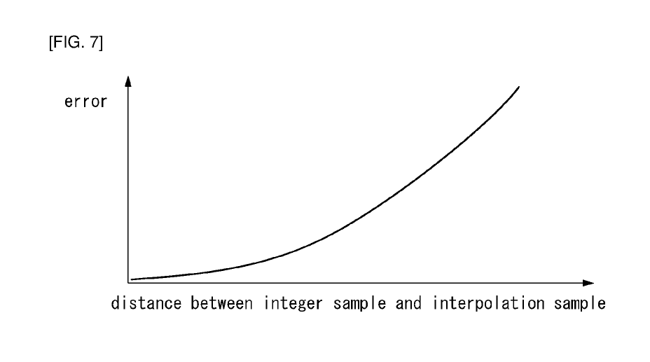

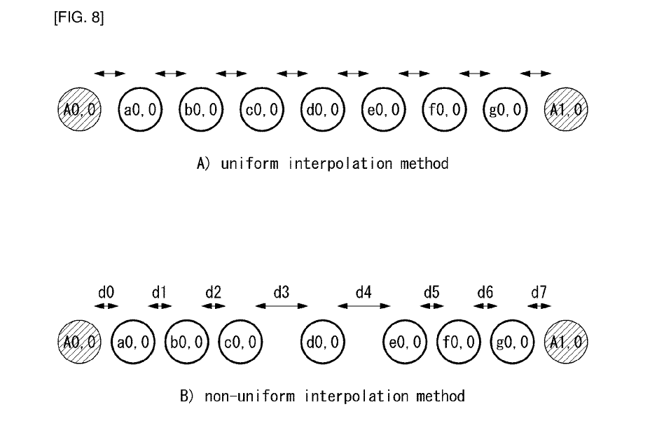

FIGS. 7 and 8 are views illustrating an interpolation method performed at the same interval or different intervals between samples according to an embodiment to which the present disclosure is applied.

Referring to the graph of FIG. 7, it can be seen that errors are increased as a distance between an integer sample and an interpolation sample is large, when interpolation is performed. This is because spatial correlation is lowered as a position of the interpolation sample is away from the integer sample. Thus, the present disclosure aims at reducing an error according to a distance between the integer sample and the interpolation sample.

An embodiment of the present disclosure provides a method for adaptively adjusting interpolation information. Here, the interpolation information may include an interpolation parameter used when performing interpolation, an interpolation flag, or the like, used for performing interpolation, and the like.

For example, the interpolation parameter may include at least one of position information of a position of an interpolation sample, information of an interval between interpolation samples, and information of the number of interpolation samples.

The position information of an interpolation sample may represent a position of the interpolation sample, and the interval information (hereinafter, referred to as a “phase interval”) of the interpolation sample may refer to an interval between interpolation samples or between an integer sample and an interpolation sample. Also, the number information may refer to the number of interpolation samples which may be generated between integer samples.

In an embodiment of the present disclosure, the phase interval may be set to be narrowed toward an integer sample. In another example, position information of an interpolation sample may be set to have a narrower interval toward an integer sample. Also, the number information of an interpolation sample may be set to be different in each processing unit (coding unit, prediction unit, etc.), block, or specific level.

Meanwhile, the interpolation flag is information representing an interpolation method and may include, for example, at least one of a method for generating an interpolation sample at a uniform interval and a method for generating an interpolation sample at a non-uniform interval. In a specific example, when the interpolation flag is 0, the method of generating an interpolation sample at a uniform interval as illustrated in FIG. 8(a) may be used, and when the interpolation flag is 1, the method of generating an interpolation sample at a non-uniform interval as illustrated in FIG. 8(b) may be used. However, the present disclosure is not limited thereto and various interpolation methods which may be inferred to in this disclosure may be applied.

An embodiment of the present disclosure provides a method for performing interpolation based on a non-uniform phase interval. Referring to FIG. 8(b), it can be seen that, in cases where 7 interpolation samples a, b, c, d, e, f, and g are generated between integer samples A_{0,0} and A_{1,0}, a phase interval is increased away from the integer sample A_{0,0} and A_{1,0}. For example, it may be d0<d1<d2<d3, and d7<d6<d5<d4. Here, the phase intervals may be symmetrical with respect to a half sample. For example, d0=d7, d1=d6, d2=d5, d3=d4, but the present disclosure is not limited thereto.

The phase interval may be determined based on at least one of training information or statistical information.

In another example, the phase interval may be determined based on characteristics of a filter used for interpolation.

In another example, the phase interval may be determined based on the number of interpolation samples. For example, in cases where 7 interpolation samples are generated between integer samples, each phase interval may be set in units of multiples.

Also, the phase interval may be defined by a flag. For example, the phase interval flag may be expressed as phase_interval. When the phase_interval is 0, a ⅛ interval may be applied, and when phase_interval is 1, a ¼ interval may be applied.

In another example, the phase interval flag may be defined as a multiple against a smallest phase interval. For example, when phase_interval=0, two times of the smallest phase interval is applied, and when phase_interval=1, four times of the smallest phase interval is applied. Also, when phase_interval=2, eight times of the smallest phase interval may be applied.

In addition, at least one of the interpolation information may be information previously set in the encoder or the decoder may be information transmitted from the encoder to the decoder.

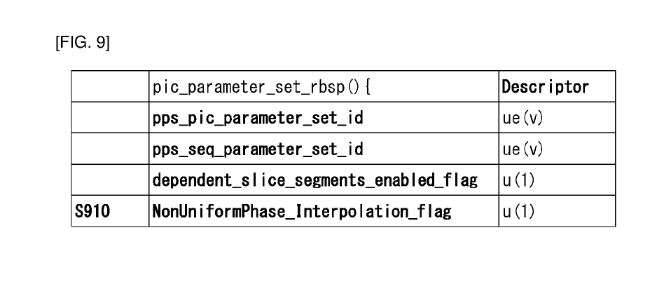

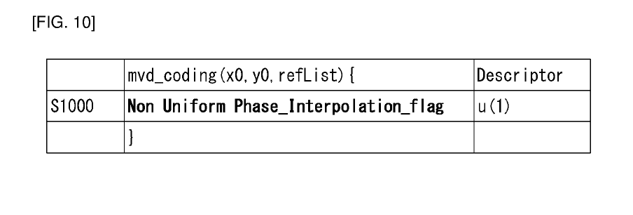

FIGS. 9 and 10 are views illustrating a syntax structure for signaling an interpolation flag representing an interpolation method according to an embodiment to which the present disclosure is applied.

In an embodiment of the present disclosure, an interpolation flag used for performing interpolation may be defined. The interpolation flag is information representing an interpolation method, and the interpolation method may include at least one of a method for generating interpolation samples at a uniform interval and a method for generating interpolation samples at a non-uniform interval, for example.

In a specific example, as illustrated in FIG. 9, the interpolation flag may be expressed as NonUniformPhase_Interpolation_flag (S910), and in this case, the interpolation flag may represent whether interpolation samples are generated at a non-uniform interval. For example, when NonUniformPhase_Interpolation_flag=0, it represents that interpolation samples are generated at a uniform interval, and when NonUniformPhase_Interpolation_flag=1, it represents that interpolation samples are generated at a non-uniform interval.

The interpolation sample may be defined at least one level of a sequence parameter set (SPS), a picture parameter set (PPS), a slice, a coding unit (CU), a prediction unit (PU), a block, a polygon, a processing unit, and a specific unit.

For example, FIG. 9 illustrates the interpolation flag defined at a picture level. As illustrated in FIG. 9, when NonUniformPhase_Interpolation_flag=1 at the PPS level, the interpolation flag may also be defined again at a lower level (e.g., slice, CU, PU, block). For example, as illustrated in FIG. 10, the interpolation flag may be defined in mvd_coding( ) of the PU level (S1000).

In this manner, an interpolation method may be differently performed in each processing unit by defining the interpolation flag at one or more levels.

In the above, the interpolation flag is limitedly defined to represent whether non-uniform interpolation is performed, but the present disclosure is not limited thereto and various interpolation methods which can be inferred in this disclosure may also be applied. For example, there may be various methods for performing non-uniform interpolation, and those methods may be defined by flag values. The method for performing non-uniform interpolation may be defined based on at least one of the number of interpolation samples and a phase interval.

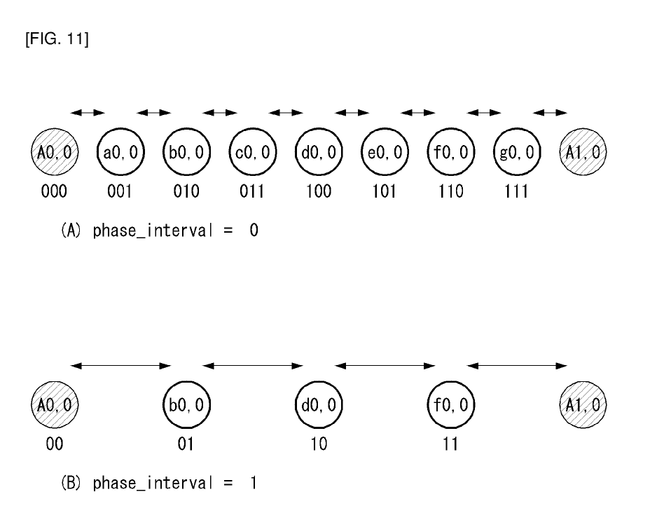

FIG. 11 is a view illustrating a method for performing interpolation based on a phase interval flag according to an embodiment to which the present disclosure is applied.

An embodiment of the present disclosure provides a method for performing interpolation based on a phase interval. Here, the phase interval may correspond to at least one of a uniform phase interval and a non-uniform phase interval.

The phase interval may be determined based on at least one of training information and statistical information, and may be information already known by the encoder or decoder.

In another example, the phase interval may be determined based on at least one of characteristics of a filter used for interpolation, the number of interpolation samples, and a phase interval flag.

For example, the phase interval flag may be expressed as phase interval, and as illustrated in FIGS. 11(a) and 11(b), when phase_interval=0, an ⅛ interval may be applied, and when phase_interval=1, a ¼ interval may be applied.

FIG. 11(a) illustrates application of interpolation filters at a uniform ⅛ interval when the phase interval flag is 0. Here, 3 bits may be required to represent a position of each interpolation sample.

FIG. 11(b) illustrates application of interpolation filters at a uniform ¼ interval when the phase interval flag is 1. Here, 2 bits may be required to represent a position of each interpolation sample.

Thus, the encoder may select a more effective case in consideration of coding efficiency of the two cases, define the more effective case by a phase interval flag, and transmit the same.

FIG. 12 is a schematic block diagram of an inter-prediction unit performing interpolation using an interpolation flag according to an embodiment to which the present disclosure is applied.

An inter-prediction unit 180/260 may include an interpolation filtering determining unit 1210, an interpolation filtering unit 1220, and a predictor generating unit 1230.

The interpolation filtering determining unit 1210 may determine which of interpolation methods is to be performed. To this end, the interpolation filtering determining unit 1210 may obtain an interpolation flag representing an interpolation method. Here, the interpolation flag is information representing an interpolation method, and the interpolation method may include at least one of a method for generating interpolation samples at a uniform interval and a method for generating interpolation samples at a non-uniform interval, for example. Or, the interpolation flag may represent whether interpolation samples are generated at a non-uniform interval. The interpolation flag may be defined at at least one level of a sequence parameter set (SPS), a picture parameter set (PPS), a slice, a coding unit (CU), a prediction unit (PU), a block, a polygon, a processing unit, and a specific unit. As an embodiment of the interpolation flag, various embodiments described above may be applied.

The interpolation filtering unit 1220 may perform interpolation filtering based on the interpolation method determined by the interpolation filtering determining unit 1210. First, position information of an integer sample within a target block is derived, and interpolation filtering according to the determining interpolation method may be performed on the integer sample based on the position information of the integer sample. Here, the interpolation filtering may refer to non-uniform interpolation filtering.

The non-uniform interpolation filtering may differ in at least one of a phase interval or the number of interpolation samples, and the phase interval represents an interval between interpolation samples, and the number of interpolation samples represents the number of interpolation samples generated between integer samples. Here, the phase interval is narrower toward the integer sample.

In another example, the phase interval may be determined based on the number of interpolation samples, or be pre-determined.

In another example, the non-uniform interpolation filtering may be applied differently to each prediction u nit. That is, non-uniform interpolation filtering may be performed on each prediction unit at different phase intervals, or non-uniform interpolation filtering may be performed on each prediction unit with different number of interpolation samples.

Also, an interpolation sample value may be derived according to the interpolation filtering result.

The predictor generating unit 1230 may obtain a prediction sample value using the interpolation sample value.

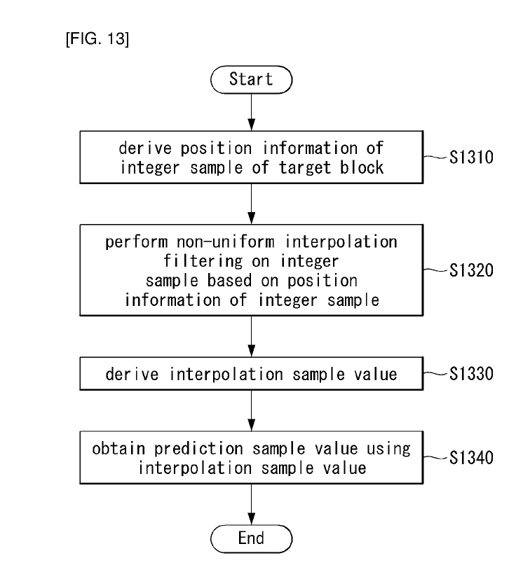

FIG. 13 is a flow chart illustrating performing non-uniform interpolation filtering according to an embodiment to which the present disclosure is applied.

First, the decoder may derive position information of an integer sample within a target block (S1310).

The decoder may perform non-uniform interpolation filtering on the integer sample based on the position information of the integer sample (S1320). Here, the non-uniform interpolation filtering may be different in at least one of a phase interval or the number of interpolation samples, and the phase interval represents an interval between interpolation samples and the number of interpolation samples may represent the number of interpolation samples generated between the integer samples.

Also, the decoder may derive an interpolation sample value according to the non-uniform interpolation filtering result (S1330).

The decoder may obtain a prediction sample value using the derived interpolation sample value (S1340).

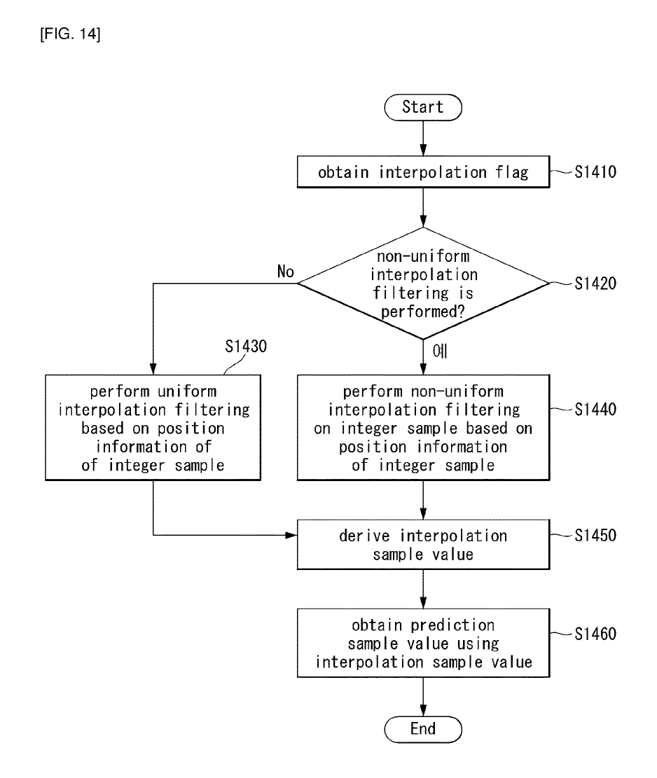

FIG. 14 is a flow chart illustrating performing non-uniform interpolation filtering based on an interpolation flag according to an embodiment to which the present disclosure is applied.

First, the decoder may obtain an interpolation flag (S1410). Here, the interpolation flag is information representing an interpolation method. For example, the interpolation method may include at least one of a method for generating interpolation samples at a uniform interval and a method for generating interpolation samples at a non-uniform interval. Or, the interpolation flag may represent whether interpolation samples are generated at a non-uniform interval.

The decoder may determine whether non-uniform interpolation filtering is performed according to the interpolation flag (S1420).

In cases where the non-uniform interpolation filtering is not performed according to the interpolation flag, the decoder may perform uniform interpolation filtering based on position information of an integer sample (S1430).

However, when non-uniform interpolation filtering is performed according to the interpolation flag, non-uniform interpolation filtering may be performed based on the position information of the integer sample (S1440). Here, the non-uniform interpolation filtering is different in at least one of a phase interval or the number of interpolation samples. The phase interval represents an interval between interpolation samples and the number of interpolation samples may represent the number of interpolation samples generated between integer samples.

The decoder may derive an interpolation sample value according to a result of the uniform interpolation filtering or the non-uniform interpolation filtering (S1450).

Also, the decoder may obtain a prediction sample value using the derived interpolation sample value (S1460).

As described above, the embodiments explained in the present invention may be implemented and performed on a processor, a micro-processor, a controller or a chip. For example, functional modules explained in FIG. 1, FIG. 2 and FIG. 12 may be implemented and performed on a computer, a processor, a microprocessor, a controller or a chip.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional 3D video apparatus, a teleconference video apparatus, and a medical video apparatus and may be used to code video signals and data signals

Furthermore, the decoding/encoding method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves, e.g., transmission through the Internet. Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1. A method for decoding a video signal, comprising:
deriving position information of an integer sample within a target block;
performing a non-uniform interpolation filtering on the integer sample based on the position information of the integer sample;
deriving an interpolation sample value according to a result of the non-uniform interpolation filtering; and
obtaining a prediction sample value using the interpolation sample value,
wherein the non-uniform interpolation filtering is different in at least one of a phase interval or the number of interpolation samples, the phase interval represents an interval between interpolation samples, and the number of interpolation samples represents the number of interpolation samples generated between integer samples.

2. The method of claim 1, wherein the phase interval is narrower toward the integer sample.

3. The method of claim 1, wherein the phase interval is determined based on the number of interpolation samples, or is pre-determined.

4. The method of claim 1, further comprising:
obtaining an interpolation flag representing an interpolation method,
wherein whether to perform the non-uniform interpolation filtering is determined based on the interpolation flag.

5. The method of claim 4, wherein the interpolation flag represents whether the non-uniform interpolation filtering is performed.

6. The method of claim 4, wherein the interpolation flag is extracted from at least one of a sequence parameter set (SPS), a picture parameter set (PPS), a slice, a coding unit (CU), a prediction unit (PU), a block, a polygon, and a processing unit.

7. The method of claim 1, wherein the non-uniform interpolation filtering is applied differently to each prediction unit.

8. An apparatus for decoding a video signal, the apparatus comprising:
an interpolation filtering unit deriving position information of an integer sample within a target block, performing non-uniform interpolation filtering on the integer sample based on the position information of the integer sample, and deriving an interpolation sample value according to a result of the non-uniform interpolation filtering; and
a predictor generating unit obtaining a prediction sample value using the interpolation sample value,
wherein the non-uniform interpolation filtering is different in at least one of a phase interval or the number of interpolation samples, the phase interval represents an interval between interpolation samples, and the number of interpolation samples represents the number of interpolation samples generated between integer samples.

9. The apparatus of claim 8, w herein the phase interval is narrower toward the integer sample.

10. The apparatus of claim 8, wherein the phase interval is determined based on the number of interpolation samples, or is pre-determined.

11. The apparatus of claim 8, further comprising:
a filtering determining unit obtaining an interpolation flag representing an interpolation method,
wherein whether to perform the non-uniform interpolation filtering is determined based on the interpolation flag.

12. The apparatus of claim 11, wherein the interpolation flag represents whether the non-uniform interpolation filtering is performed.

13. The apparatus of claim 11, wherein the interpolation flag is extracted from at least one of a sequence parameter set (SPS), a picture parameter set (PPS), a slice, a coding unit (CU), a prediction unit (PU), a block, a polygon, and a processing unit.

14. The apparatus of claim 8, wherein the non-uniform interpolation filtering is applied differently to each prediction unit.
